(19) United States
(12) Patent Application Publication
(10) Pub. No.: US 2019/0239484 A1
(43) Pub. Date: Aug. 8, 2019

(54) DAIRY COWSHED MONITORING SYSTEM AND METHOD THEREOF

(71) Applicant: National Taiwan University, Taipei (TW)

(72) Inventors: Yu-Chi Tsai, Taipei (TW); Chen-Yu Cheng, Taipei (TW); Jih-Tay Hsu, Taipei (TW); Shih-Torng Ding, Taipei (TW); Ta-Te Lin, Taipei (TW)

(21) Appl. No.: 15/961,683

(22) Filed: Apr. 24, 2018

(30) Foreign Application Priority Data
Feb. 8, 2018 (TW) 107104576

(51) Int. Cl. A01K 29/00; G01K 13/00; G01F 9/00; G01N 25/56; A01K 1/00

(52) U.S. Cl. CPC A01K 29/005; G01K 13/00; A01K 1/0082; G01N 25/56; A01K 1/0052; G01F 9/00

(57) ABSTRACT

A dairy cowshed monitoring system includes a cooling system having a plurality of operating modes, at least one image sensor, at least one temperature/humidity sensor, and a control circuit. The image sensor is for collecting image data in a dairy cowshed and obtaining a cow drinking water frequency in the dairy cowshed. The temperature/humidity sensor is for collecting a temperature and a humidity in the dairy cowshed and calculating a temperature/humidity index according to the temperature and the humidity. The control circuit is coupled to the cooling system, the image sensor and the temperature/humidity sensor and for receiving the image data, the cow drinking water frequency and the temperature/humidity index and determining whether to activate and control the cooling system in one of the operating modes to cool the dairy cowshed according to the cow drinking water frequency and the temperature/humidity index.

### TECHNICAL FIELD

The present invention relates to a dairy cowshed monitoring system and a method thereof, and more particularly to a dairy cowshed monitoring system and a method thereof capable of controlling a cooling system to cool the dairy cowshed according to the cow drinking water frequency and the temperature/humidity index so as to reduce the heat stress of the cow.

### BACKGROUND

Cows are often exposed to heat stress and the heat stress may affect their physiology. The low heat stress may cause the cow to suffer from loss of appetite, having affected development, reproduction and lactation. In high heat stress may cause the cow to have hepatic ulcers, hypocalcemia, blood ion imbalances, and eventually death. Therefore, the heat-stress problem will directly increase the production cost of dairy products and reduce the production volume, which will affect the supply of dairy products. Because the most effective method of reduce the cow's heat stress is to cool the dairy cowshed, how and when to use the cooling system to cool the dairy cowshed is also one of the important issues at present.

### SUMMARY

Therefore, the embodiment of the present invention provides a dairy cowshed monitoring system, which includes a cooling system having a plurality of operating modes, at least one image sensor, at least one temperature/humidity sensor, and a control circuit. The image sensor is for collecting image data in a dairy cowshed and obtaining a cow drinking water frequency in the dairy cowshed. The temperature/humidity sensor is for collecting a temperature and a humidity in the dairy cowshed and calculating a temperature/humidity index according to the temperature and the humidity. The control circuit is coupled to the cooling system, the image sensor and the temperature/humidity sensor and for receiving the image data, the cow drinking water frequency and the temperature/humidity index and determining whether to activate and control the cooling system in one of the operating modes to cool the dairy cowshed according to the cow drinking water frequency and the temperature/humidity index.

The embodiment of the present invention further provides a dairy cowshed monitoring method performed in the aforementioned dairy cowshed monitoring system. The dairy cowshed monitoring method includes the following steps: configuring the image sensor to collect image data in a dairy cowshed and obtain a cow drinking water frequency in the dairy cowshed; configuring the temperature/humidity sensor to collect a temperature and a humidity in the dairy cowshed and calculate a temperature/humidity index according to the temperature and the humidity; and configuring the control circuit to receive the image data, the cow drinking water frequency and the temperature/humidity index and determine whether to activate and control the cooling system in one of the operating modes to cool the dairy cowshed according to the cow drinking water frequency and the temperature/humidity index.

### BRIEF DESCRIPTION OF THE DRAWINGS

The present disclosure will become more readily apparent to those ordinarily skilled in the art after reviewing the following detailed description and accompanying drawings, in which:

FIG. 1 is a functional block diagram of a dairy cowshed monitoring system provided by an embodiment of the present invention; and

FIG. 2 is flow chart of a milking cowshed monitoring method provided by an embodiment of the present invention.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

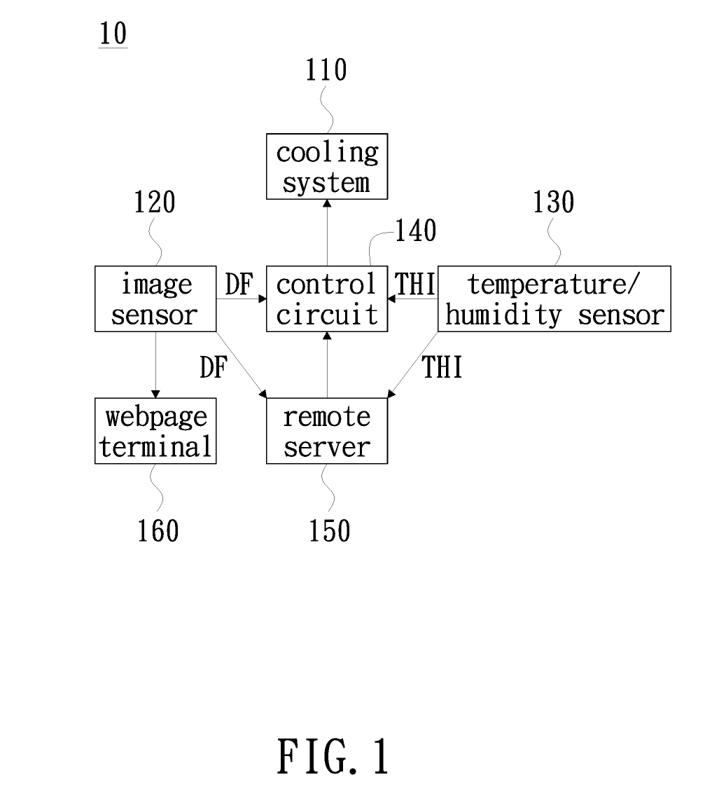

Please refer to FIG. 1. FIG. 1 is a functional block diagram of a dairy cowshed monitoring system provided by an embodiment of the present invention. The dairy cowshed monitoring system 10 may include a cooling system 110, at least one image sensor 120, at least one temperature/humidity sensor 130 and a control circuit 140. It should be noted that the cooling system 110, the image sensor 120, the temperature/humidity sensor 130 and the control circuit 140 may be implemented through a pure hardware circuit or implemented through a hardware circuit with firmware or software, and the present invention is not limited thereto. In addition, the above elements may be integrated or separated, and the present invention is not limited thereto. In addition, in order to facilitate the following description, the image sensor 120 and the temperature/humidity sensor 130 of the present embodiment are only described by using an example where the numbers are all one, but the present invention is not limited thereto.

In the present embodiment, the cooling system 110 may be, for example, a system composed of a fan (not shown), a sprinkler (not shown) and a sprayer (not shown), but the present invention is not limited thereto. In summary, the present invention does not limit the specific implementation of the cooling system 110, and those skilled in the art can perform related design of the cooling system 110 according to actual requirements or applications. In addition, the cooling system 110 may have a plurality of operating modes (not shown), and the specific content of the operating modes will be described in detail below by other embodiments, and no redundant detail is to be given herein.

On the other hand, the image sensor 120 may be, for example, a Pi camera, and it is installed above at least one water trough (not shown) in a dairy cowshed (not shown). The image sensor 120 is used for collecting image data (not shown) in the dairy cowshed and obtaining the cow drinking water frequency DF in the dairy cowshed. The temperature/humidity sensor 130 may be, for example, a DHT22 digital temperature/humidity sensor, which is used for collecting the temperature and humidity in the dairy cowshed and calculating the temperature/humidity index THI according to the temperature and humidity. In the present embodiment, the equation adopted by the temperature/humidity sensor 130 to calculate the temperature/humidity index THI according to temperature and humidity can be expressed as THI=(1.8×T+32)−(0.55−0.0055×H)×(1.8×T−26), wherein T and H are temperature (° C.) and humidity (%), respectively. It should be noted that the above equation is only an example here and the present invention is not limited thereto. That is, those skilled in the art can perform related design of the temperature/humidity index THI calculation equation according to actual requirements or applications. In addition, the control circuit 140 is coupled to the cooling system 110, the image sensor 120 and the temperature/humidity sensor 130. The control circuit 140 is used for receiving the image data, the cow drinking water frequency DF and the temperature/humidity index THI and determining whether to activate and control the cooling system 110 to cool the dairy cowshed in one of it's a plurality operating modes according to the cow drinking water frequency DF and the temperature/humidity index THI.

In general, because heat stress is a kind of environmental stress, the existing dairy cowshed monitoring system may directly use the temperature in the dairy cowshed as a ranking index for deciding whether to activate and control the cooling system 110 to cool the dairy cowshed in different operating modes. For example, the cooling system 110 may have two operating modes of “fan full open” and “fan half open”. Therefore, when the existing dairy cowshed monitoring system finds that the temperature in the dairy cowshed is not higher than a certain critical value (for example, 15° C.) which indicates that no heat stress occurs, the existing dairy cowshed monitoring system will decide not to activate the cooling. When the existing dairy cowshed monitoring system finds that the temperature in the dairy cowshed is above this critical value but is within a certain allowable range (for example, 15° C. to 24° C.), the existing dairy cowshed monitoring system will decide to activate and control the cooling system 110 to cool the dairy cowshed in the operating mode of “fan half open”. Similarly, when the existing dairy cowshed monitoring system finds that the temperature in the dairy cowshed is even higher than the upper limit of the allowable range (for example, 24° C.), the existing dairy cowshed monitoring system will decide to activate and control the cooling system 110 to cool the dairy cowshed in the operating mode of “fan full open”.

On the other hand, the existing dairy cowshed monitoring system more often uses the temperature/humidity index THI as a ranking index for deciding whether to activate and control the cooling system 110 to cool the dairy cowshed in different operating modes. For example, the cooling system 110 may also have three operating modes of “1 minute sprinkler or sprayer every 15 minutes”, “1 minute sprinkler or sprayer every 10 minutes” and “1 minute sprinkler or sprayer every 5 minutes”. Thus, when the existing dairy cowshed monitoring system finds that the temperature/humidity index THI in the dairy cowshed is within a range of low heat stress (for example, 72 to 78), the existing dairy cowshed monitoring system will decide to activate and control the cooling system 110 to cool the dairy cowshed in the operating mode of “1 minute sprinkler or sprayer every 15 minutes”. When the existing dairy cowshed monitoring system finds that the temperature/humidity index THI in the dairy cowshed is above this range of low heat stress but is within a middle heat stress range (for example, 78 to 88), the existing dairy cowshed monitoring system will decide to activate and control the cooling system 110 to cool the dairy cowshed in the operating mode of “1 minute sprinkler or sprayer every 10 minutes”. Similarly, when the existing dairy cowshed monitoring system finds that the temperature/humidity index THI in the dairy cowshed is even higher than the upper limit of the middle heat stress range (for example, 78 to 88) which indicates that a high heat occurs, the existing dairy cowshed monitoring system will decide to activate and control the cooling system 110 to cool the dairy cowshed in the operating mode of “1 minute sprinkler or sprayer every 5 minutes”.

In summary, from the above, it can be seen that the existing dairy cowshed monitoring systems only consider the use of “environmental factors” as the grading indicators for deciding whether to start and control the cooling system 110 in different operating modes to cool the dairy cowshed. However, because the heat stress will also easily lead to a change in the activity status of the dairy cow, for example, the frequency of dairy cows drinking water increases; therefore, compared to the prior art, the dairy cowshed monitoring system 10 of the embodiment of the present invention takes more consideration of the use of biological factors (i.e., dairy cow drinking water frequency DF) for synchronization as a ranking index for deciding whether to activate and control the cooling system 110 to cool the dairy cowshed in different operating modes. Therefore, in the present embodiment, the control circuit 140 may substitute the cow drinking water frequency DF and the temperature/humidity index THI into a weighting equation, and through the weighting equation the dairy cowshed monitoring system 10 can intuitively understand the current heat stress of dairy cows in the dairy cowshed now.

For example, the weighting equation may be expressed as α1×THI+α2×DF, and α1 and α2 are parameter weights of the temperature/humidity index THI and the cow drinking water frequency DF, respectively, but the present invention is not limited thereto. From the teachings of the above content, the control circuit 140 of the present embodiment may also firstly plan a plurality of numerical ranges of different heat-stress degrees, and each heat-stress degree is able to correspond to one of the operating modes of the cooling system 110. Then, the control circuit 140 determines the heat stress level according to the result of the weighting equation and then determines to activate and control the cooling system 110 to reduce the temperature of the dairy cowshed according to the operating mode corresponding to the heat stress degree. That is, the control circuit 140 of the present embodiment may control the cooling system 110 to reduce the temperature of the dairy cowshed in different operating modes according to the cow drinking water frequency DF and the temperature/humidity index THI, thereby effectively reducing the impact of the heat stress on the dairy cows in the dairy cowshed. Similarly, if the control circuit 140 determines that the result of the weighting equation is lower than the numerical range of the heat-stress degree (that is, no heat stress occurs), the control circuit 140 may also decide not to activate the cooling system 110 to cool the dairy cowshed.

In addition, in the present embodiment, the dairy cowshed monitoring system 10 may further include a remote server 150 coupled to the control circuit 140, the image sensor 120 and the temperature/humidity sensor 130. The remote server 150 is used for storing the aforementioned image data, the cow drinking water frequency DF, the temperature, the humidity and the temperature/humidity index THI. After a fixed period of time, the remote server 150 is able to feedback the parameter weights (i.e., α1 and α2) in the aforementioned weighting equation for adjustment according to the change in the received cow drinking water frequency DF. Similarly, in the present embodiment, the control circuit 140 may further include a storage (not shown), and the storage is also for storing the aforementioned image data, the cow drinking water frequency DF and the temperature/humidity index THI. Since the operating principles of the remote server 150 and the aforementioned storage are well known to those of ordinary skill in the art, no redundant detail is to be given herein.

Further, the image sensor 120 is used for recording the movement track and the start and end of drinking time of at least one dairy cow in the dairy cowshed by means of object tracking and object detection, so as to calculate the amount of drinking water and the number of drinking times of the dairy cow and obtain the cow drinking water frequency DF. In addition, the image sensor 120 further transmits the drinking water amount, the drinking times and the cow drinking water frequency DF to the remote server 150 and a webpage terminal 160 for at least one administrator (not shown) to remotely monitor the dairy cowshed. Since the methods of object tracking and object detection are also known to those of ordinary skill in the art, no redundant detail is to be given herein. In summary, it can be seen from the above that the dairy cowshed monitoring system 10 of the present embodiment can perform automatic image monitoring so that the staff in the dairy cowshed do not need to be on site and is able to keep track of the cows in the dairy cowshed at any time.

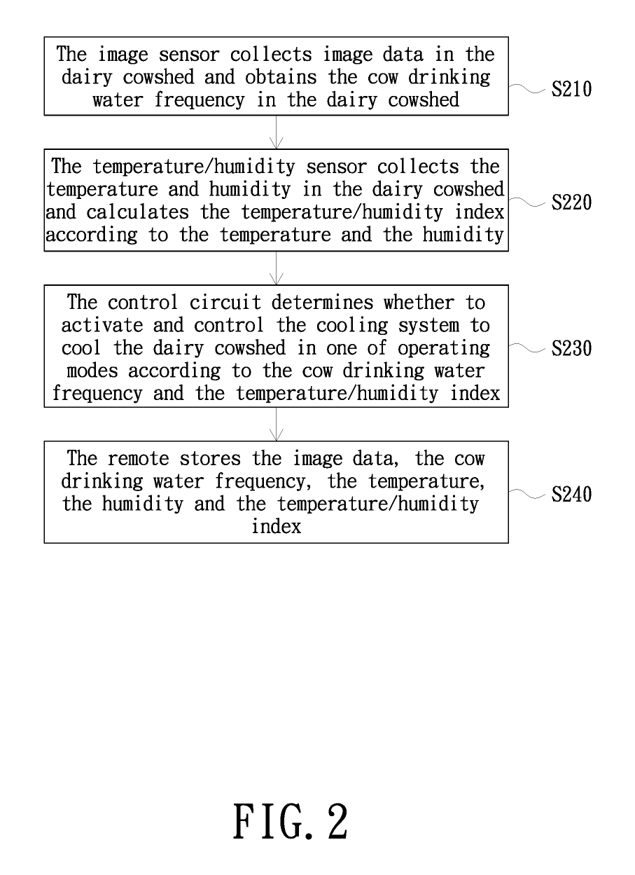

Next, in order to further explain the operation flow of the dairy cowshed monitoring system 10, the present invention further provides an embodiment of a dairy cowshed monitoring method. Please refer to FIG. 2. FIG. 2 is a flowchart of a dairy cowshed monitoring method according to an embodiment of the present invention. The dairy cowshed monitoring method of FIG. 2 can be applied to the dairy cowshed monitoring system 10, so please also refer to FIG. 1 for the better understanding of the present invention, but the present invention does not limit the dairy cowshed monitoring method of FIG. 2 can only be performed in the dairy cowshed monitoring system 10 of FIG. 1. In addition, the detailed step flow is as described in the foregoing embodiment, and is merely summarized herein without being redundant.

First, in step S210, the image sensor 120 is used for collecting the image data in the dairy cowshed and obtaining the cow drinking water frequency DF in the dairy cowshed. Thereafter, in step S220, the temperature/humidity sensor 130 is used for collecting the temperature and humidity in the dairy cowshed and calculating the temperature/humidity index THI according to the temperature and the humidity. Thereafter, in step S230, the control circuit 140 is used for receiving the image data, the cow drinking water frequency DF and the temperature/humidity index THI and determining whether to activate and control the cooling system 110 in one of a plurality of operating modes to cool the dairy cowshed according to the cow drinking water frequency DF and the temperature/humidity index THI. According to the teachings of the above contents, those skilled in the art should understand that step S210 and step S220 could be executed in parallel without conflicting steps.

In addition, as described in the previous embodiments, the dairy cowshed monitoring system 10 may further include a remote server 150 coupled to the control circuit 140, the image sensor 120 and the temperature/humidity sensor 130. Therefore, the dairy cowshed monitoring method of FIG. 2 may further include step S240. In step S240, the remote server 150 stores the image data, the cow drinking water frequency DF, the temperature, the humidity and the temperature/humidity index THI. After a fixed period of time, the remote server 150 is able to feedback the parameter weights in the aforementioned weighting equation for adjustment according to the change in the received cow drinking water frequency DF. Since detailed implementation details are as described in the foregoing embodiments, no redundant detail is to be given herein.

In summary, the dairy cowshed monitoring system and method provided by the embodiments of the present invention can perform automatic image monitoring so that the staff in the dairy cowshed do not need to be on site and is able to keep track of the cows in the dairy cowshed at any time. In addition, the dairy cowshed monitoring system and its method of the present invention use an image sensor to automatically calculate the cow drinking water frequency and use the correlation between the cow drinking water frequency and the heat stress as the ranking index, according which the control circuit can determine whether to activate and control the cooling system to cool the dairy cowshed in one of it's a plurality operating modes, so as to effectively reduce the impact of the heat stress on the dairy cows in the dairy cowshed and to achieve stable milk production quality.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A dairy cowshed monitoring system, comprising:
a cooling system, having a plurality of operating modes;
at least one image sensor, for collecting image data in a dairy cowshed and obtaining a cow drinking water frequency in the dairy cowshed;
at least one temperature/humidity sensor, for collecting a temperature and a humidity in the dairy cowshed and calculating a temperature/humidity index according to the temperature and the humidity; and
a control circuit, coupled to the cooling system, the image sensor and the temperature/humidity sensor, for receiving the image data, the cow drinking water frequency and the temperature/humidity index and determining whether to activate and control the cooling system in one of the operating modes to cool the dairy cowshed according to the cow drinking water frequency and the temperature/humidity index.

2. The dairy cowshed monitoring system according to claim 1, further comprising:
a remote server, coupled to the control circuit, the image sensor and the temperature/humidity sensor, for storing the image data, the cow drinking water frequency, the temperature, the humidity and the temperature/humidity index.

3. The dairy cowshed monitoring system according to claim 2, wherein the image sensor is installed above at least one water trough in the dairy cowshed, and the image sensor is used for recording a movement track and a start and end of drinking time of at least one dairy cow in the dairy cowshed by means of object tracking and object detection, so as to calculate an amount of drinking water and a number of drinking times of the dairy cow and obtain the cow drinking water frequency.

4. The dairy cowshed monitoring system according to claim 3, wherein the image sensor further transmits the amount of drinking water, the number of drinking times and the cow drinking water frequency to the remote server and a webpage terminal so that at least one administrator can remotely monitor the dairy cowshed.

5. The dairy cowshed monitoring system according to claim 1, wherein the control circuit further comprises a storage for storing the image data, the cow drinking water frequency and the temperature/humidity index.

6. A dairy cowshed monitoring method performed in a dairy cowshed monitoring system, the dairy cowshed monitoring system comprising a cooling system with a plurality of operating modes, at least one image sensor, at least one temperature/humidity sensor and a control circuit, the dairy cowshed monitoring method comprising:
configuring the image sensor to collect image data in a dairy cowshed and obtain a cow drinking water frequency in the dairy cowshed;
configuring the temperature/humidity sensor to collect a temperature and a humidity in the dairy cowshed and calculate a temperature/humidity index according to the temperature and the humidity; and
configuring the control circuit to receive the image data, the cow drinking water frequency and the temperature/humidity index and determine whether to activate and control the cooling system in one of the operating modes to cool the dairy cowshed according to the cow drinking water frequency and the temperature/humidity index.

7. The dairy cowshed monitoring method according to claim 6, wherein the dairy cowshed monitoring system further comprises a remote server and the dairy cowshed monitoring method further comprises:
configuring the remote server to store the image data, the cow drinking water frequency, the temperature, the humidity and the temperature/humidity index.

8. The dairy cowshed monitoring method according to claim 7, wherein the image sensor is installed above at least one water trough in the dairy cowshed, and the image sensor is used for recording a movement track and a start and end of drinking time of at least one dairy cow in the dairy cowshed by means of object tracking and object detection, so as to calculate an amount of drinking water and a number of drinking times of the dairy cow and obtain the cow drinking water frequency.

9. The dairy cowshed monitoring method according to claim 8, wherein the image sensor further transmits the amount of drinking water, the number of drinking times and the cow drinking water frequency to the remote server and a webpage terminal so that at least one administrator can remotely monitor the dairy cowshed.

10. The dairy cowshed monitoring method according to claim 6, wherein the control circuit further comprises a storage for storing the image data, the cow drinking water frequency and the temperature/humidity index.
